(19) United States
(12) Patent Application Publication
(10) Pub. No.: US 2026/0037975 A1
(43) Pub. Date: Feb. 5, 2026

(54) DETECTING FRAUDULENT OR ILLICIT ACTIVITY IN PEER-TO-PEER TRANSACTIONS USING NATURAL LANGUAGE PROCESSING

(71) Applicant: Capital One Services, LLC, McLean, VA (US)

(72) Inventors: Aaron ATTAR, Dallas, TX (US); Eitan ISSER, New York, NY (US)

(21) Appl. No.: 18/792,390

(22) Filed: Aug. 1, 2024

(51) Int. Cl. G06Q 20/40; G06Q 20/22

(52) U.S. Cl. CPC G06Q 20/4016; G06Q 20/223

(57) ABSTRACT

In some implementations, a system may obtain information associated with indicators related to fraudulent or illicit activity in P2P transactions. The system may receive, from a first user device, a request for a P2P transaction. The system may analyze textual information related to the P2P transaction using natural language processing (NLP) to determine whether the P2P transaction includes one or more of the indicators related to fraudulent or illicit activity. The system may process the request for the P2P transaction in accordance with whether the P2P transaction includes one or more of the indicators related to fraudulent or illicit activity. For example, the system may trigger a remediation action based on the textual information including indicators related to fraudulent or illicit activity, or may process the P2P transaction based on the textual information lacking indicators related to fraudulent or illicit activity or including indicators of legitimate activity.

### BACKGROUND

Natural language processing (NLP) is an interdisciplinary subfield in computer science and information retrieval that is primarily concerned with giving computers the ability to support and manipulate human language. NLP involves processing natural language datasets, such as text corpora or speech corpora, using either rule-based or probabilistic (e.g., statistical and/or neural-network-based) machine learning approaches. NLP techniques are aimed at providing a computer with a capability to understand words and phrases, including the contextual nuances of language. To this end, NPL often implements concepts from theoretical linguistics to accurately extract information and/or insights contained in text corpora or speech corpora and/or to categorize and organize the content.

### SUMMARY

Some implementations described herein relate to a system for detecting fraudulent or illicit activity in peer-to-peer (P2P) transactions. The system may include one or more memories and one or more processors communicatively coupled to the one or more memories. The one or more processors may be configured to obtain information associated with indicators related to fraudulent or illicit activity in P2P transactions. The one or more processors may be configured to receive textual information related to a P2P transaction between a sending user and a receiving user, wherein the textual information related to the P2P transaction includes one or more of: text that the sending user provided in a memo to accompany the P2P transaction, or text that the receiving user provided to request the P2P transaction. The one or more processors may be configured to analyze the textual information related to the P2P transaction using natural language processing (NLP) to determine whether the P2P transaction includes one or more of the indicators related to fraudulent or illicit activity. The one or more processors may be configured to trigger a remediation action for the P2P transaction based on the textual information including the one or more of the indicators related to fraudulent or illicit activity.

Some implementations described herein relate to a method for assessing a risk of fraudulent or illicit activity in P2P transactions. The method may include obtaining, by a system, information associated with indicators related to fraudulent or illicit activity in P2P transactions. The method may include receiving, from a user device associated with a sending user, a request for a P2P transaction between the sending user and a receiving user. The method may include analyzing, by the system, textual information related to the P2P transaction using NLP to determine whether the P2P transaction includes one or more of the indicators related to fraudulent or illicit activity, wherein the textual information related to the P2P transaction includes one or more of: text that the sending user provided in a memo to accompany the P2P transaction, or text that the receiving user provided to request the P2P transaction. The method may include processing, by the system, the request for the P2P transaction in accordance with whether the P2P transaction includes the one or more of the indicators related to fraudulent or illicit activity, wherein processing the request for the P2P transaction includes: triggering a remediation action for the P2P transaction based on the textual information including the one or more indicators related to fraudulent or illicit activity, or processing the P2P transaction based on the textual information lacking indicators related to fraudulent or illicit activity or including indicators of legitimate activity.

Some implementations described herein relate to a non-transitory computer-readable medium that stores a set of instructions. The set of instructions, when executed by one or more processors of a system, may cause the system to obtain information associated with indicators related to fraudulent or illicit activity in P2P transactions. The set of instructions, when executed by one or more processors of the system, may cause the system to receive, from a requesting system, an API call that includes a request to assess a P2P transaction between a sending user and a receiving user for fraudulent or illicit activity and indicates information related to the P2P transaction, wherein the information indicated in the request includes one or more of: text that the sending user provided in a memo to accompany the P2P transaction, text that the receiving user provided to request the P2P transaction, a value of the P2P transaction, information related to one or more behavior patterns associated with an account of the sending user, or information related to one or more behavior patterns associated with an account of the receiving user. The set of instructions, when executed by one or more processors of the system, may cause the system to analyze the information related to the P2P transaction using one or more machine learning models to determine whether the P2P transaction includes one or more of the indicators related to fraudulent or illicit activity. The set of instructions, when executed by one or more processors of the system, may cause the system to send, to the requesting system, an indication of whether the P2P transaction includes one or more of the indicators related to fraudulent or illicit activity.

### BRIEF DESCRIPTION OF THE DRAWINGS

FIG. 1 is a diagram of an example associated with detecting fraudulent or illicit activity in P2P transactions using NLP, in accordance with some embodiments of the present disclosure.

FIG. 2 is a diagram illustrating an example of training and using a machine learning model in connection with detecting fraudulent or illicit activity in P2P transactions using NLP, in accordance with some embodiments of the present disclosure.

FIG. 3 is a diagram of an example environment in which systems and/or methods described herein may be implemented, in accordance with some embodiments of the present disclosure.

FIG. 4 is a diagram of example components of a device associated with detecting fraudulent or illicit activity in P2P transactions using NLP, in accordance with some embodiments of the present disclosure.

FIG. 5 is a flowchart of an example process associated with detecting fraudulent or illicit activity in P2P transactions using NLP, in accordance with some embodiments of the present disclosure.

### DETAILED DESCRIPTION

The following detailed description of example implementations refers to the accompanying drawings. The same reference numbers in different drawings may identify the same or similar elements.

As described herein, a P2P transaction or P2P payment is a digital funds transfer made between a sending user and a receiving user without using traditional banking or transaction systems such as a credit card, debit card, cash, or check. Instead, a P2P payment typically occurs through a mobile application or online through a website associated with a P2P service provider, such as PayPal, Venmo, Cash App, or Zelle. P2P services have become an increasingly popular and convenient way to quickly send money to others (e.g., to split a bill, pay rent, send a gift, and/or pay for a product or service, among other examples). However, P2P transactions are often exploited in scams and fraud schemes, such as phishing, unauthorized money transfers, “accidental” transfers, and/or impersonation scams, among other examples. In addition, P2P transactions can be misused for illicit or illegal activity, such as money laundering, illegal drug sales, human trafficking, funding foreign terrorist organizations (FTOs), and/or selling personally identifying information (PII), among other examples. Accordingly, significant resources are expended to detect and/or prevent fraudulent or illicit activity in P2P transactions. However, detecting and/or preventing fraud or criminal behavior in P2P payment services presents several technical challenges, due to the nature of the P2P payment platforms and the sophisticated methods that are employed by fraudsters and/or criminals.

For example, P2P transaction platforms offer anonymity and privacy, often requiring minimal personal information, which can pose challenges with respect to verifying identities and detecting fraudulent accounts and/or having a limited capability to identify suspicious behavior in order to comply with privacy laws. In addition, P2P transaction platforms need to process high transaction volumes in real-time or near real-time, which limits the window to detect and/or prevent fraudulent or illicit activities prior to completion and/or requires scalable infrastructure and/or sophisticated algorithms to detect anomalies. Furthermore, fraudulent and/or illegal behaviors and tactics are constantly evolving, which requires near-continuous updates to detection algorithms and/or systems, and aggressive detection mechanisms that can result in a high number of false positives, which can lead to increased resource consumption to remediate, in addition to inconveniencing legitimate users and reducing trust in the P2P payment service. Further still, detecting and/or preventing fraud and/or illegal activity may involve analyzing groups of transactions to identify suspicious patterns in payment networks, which can be computationally intensive and complex, and fraudsters and/or criminals may use multiple accounts or P2P payment services to create complex schemes that may be challenging to detect through simple transaction analysis.

In some implementations, as described herein, a P2P risk system may use natural language processing (NLP) analysis, alone or in combination with artificial intelligence or machine learning techniques, to detect indicators of fraud and/or illicit activities in P2P transactions. For example, in many P2P transactions, a sending user may include words, phrases, emojis, animations, images, or other content in a memo or description that accompanies the P2P transaction, and a receiving user may include similar content in a memo or description that accompanies a request for a P2P transaction. Accordingly, the P2P risk system may obtain indicators of fraudulent or illicit activities, such as words or phrases used in fraudulent P2P payment scams, FTO slogans, jargon associated with fraud schemes and/or illegal activities, or the like. In addition, the indicators of fraudulent or illicit activities may include information related to communication tactics that are used in P2P payment scams (e.g., communication techniques to obtain victim trust or to trick victims) and/or tactics to structure P2P transactions or P2P transaction accounts to evade detection (e.g., altering word spellings or using emojis to mask a true meaning, creating fake identities, breaking down large transactions into several smaller transactions, or the like). In some implementations, when a sending user initiates a P2P transaction, the P2P risk system may analyze the P2P transaction using NLP and/or machine learning techniques to determine whether the P2P transaction includes any indicators of fraud or illicit activity. For example, in some implementations, the P2P risk system may be integrated within a P2P service provider system, or may be accessible to a P2P service provider via an application program interface (API) call. In either case, the P2P risk system may initiate a remedial action when the P2P transaction includes indicators of fraud or illicit activity, such as blocking the P2P transaction, flagging the P2P transaction for further review or monitoring, or the like, or may allow the P2P transaction to proceed when the P2P transaction does not include indicators of fraud or illicit activity. Furthermore, in some cases, the P2P risk system may provide one or more application modules or functions that can be integrated into a mobile P2P payment application or P2P payment website to provide front-end integration (e.g., verifying that a P2P transaction request does not include indicators of fraud or illicit activity before the P2P transaction request is allowed to be sent to the P2P service provider, and/or flagging a P2P transaction request that includes indicators of fraud or illicit activity such that law enforcement or other entities can monitor accounts and/or users and apprehend fraudsters or criminals).

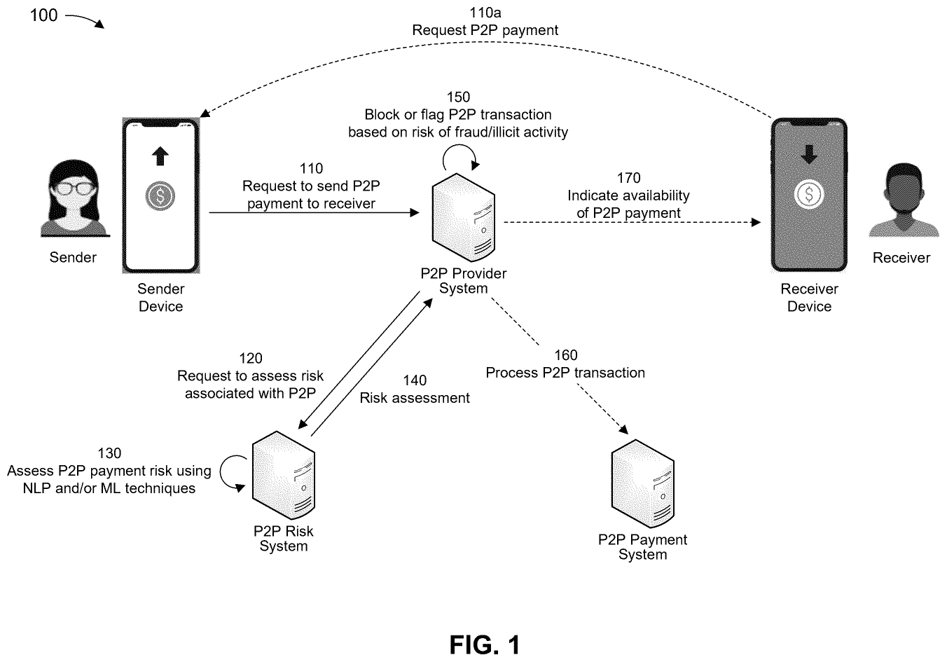

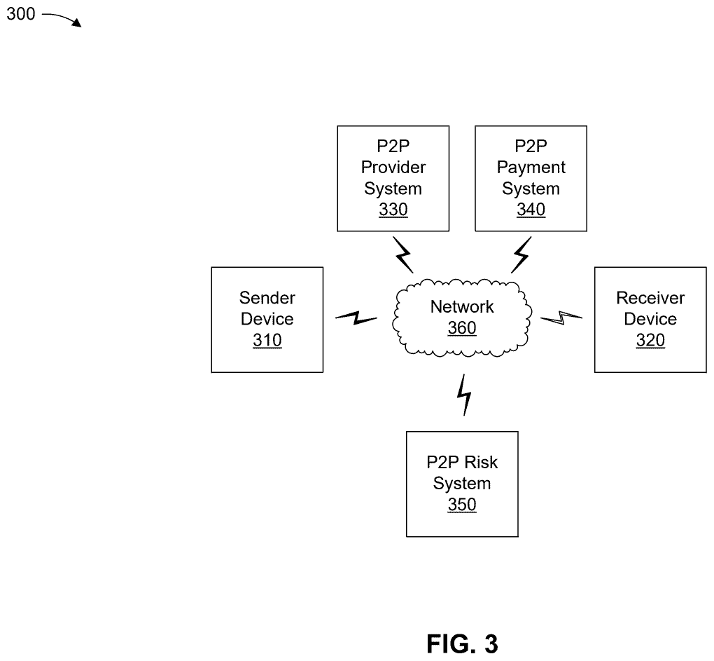

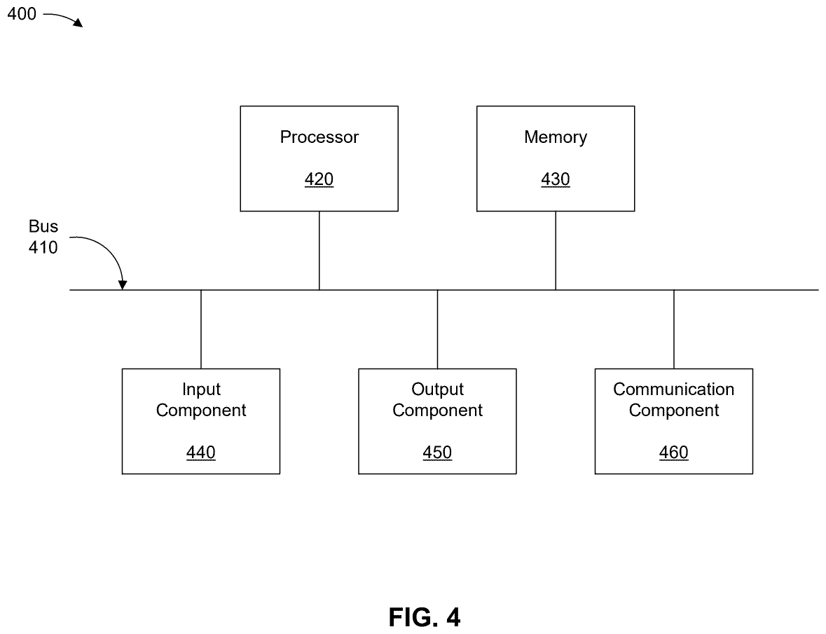

FIG. 1 is a diagram of an example 100 associated with detecting fraudulent or illicit activity in P2P transactions using NLP. As shown in FIG. 1, example 100 includes a sender device, a receiver device, a P2P provider system, a P2P risk system, and a P2P payment system. The sender device, the receiver device, the P2P provider system, the P2P risk system, and the P2P payment system are described in more detail in connection with FIG. 3 and FIG. 4.

As shown in FIG. 1, and by reference number 110, a P2P provider system may receive, from a sender device associated with a sending user, a request to send a P2P payment to a receiving user associated with a receiver device. For example, as described herein, the P2P provider system may be associated with a P2P payment service provider, such as Venmo, PayPal, Cash App, Zelle, or the like, and the request to send the P2P payment may be initiated via a mobile application running on the sender device and/or online via a website of the P2P payment service provider. For example, in some implementations, the sending user may generally have an account with the P2P provider system (or may establish the account in connection with the request for the P2P transaction), where the account may be associated with an identity of the sending user and linked to one or more bank accounts, credit cards, or other payment credentials that are supported by the P2P provider system (e.g., a cryptocurrency wallet). Furthermore, when the sending user provides the request to send the P2P payment to the receiver, the sending user may input a memo or description of the P2P payment. For example, the memo or description may include text, numbers, emojis, animations, images, or any other suitable content, which may be private (e.g., visible only to the sending user and the receiving user), publicly visible (e.g., visible to all users of the P2P service), and/or semi-publicly visible (e.g., visible only to friends, family members, users in a contacts list, and/or users that have sent P2P payments to or received P2P payments from the sending user and/or the receiving user).

In some implementations, the sending user may initiate the request for the P2P payment independently, by selecting a payment option in the mobile application or website and inputting details of the receiving user. Additionally, or alternatively, as shown by reference number 110a, the receiving user may request the P2P payment from the sending user, and the sending user may initiate the request for the P2P payment by selecting the payment option in the mobile application or the website in association with the request from the receiving user. For example, in some implementations, the receiving user may input a memo or description to accompany the request for the P2P payment (e.g., indicating what the P2P payment is for, such as goods or services rendered, a shared expense, or the like) and indicate the requested amount of the P2P transaction, and the P2P provider system may route the request to the sender device to request the P2P payment from the sending user. In another example, in order to request a P2P payment, a mobile application on the receiver device may provide an option to display a readable code (e.g., a QR code or bar code) or to communicate information over a short-range interface (e.g., using a Bluetooth or near-field-communication (NFC) protocol), and the sender device may scan the readable code or receive the information over the short-range interface.

In some implementations, as shown by reference number 120, the P2P risk system may receive a request to assess a risk associated with the requested P2P payment from the P2P provider system. For example, in some implementations, the P2P risk system may be integrated within the P2P provider system (e.g., operated by or otherwise associated with the P2P service provider), or the P2P risk system may be provided as a third-party service that receives the request to assess the risk associated with the P2P transaction via an API call. In either case, as shown by reference number 130, the P2P risk system may then assess a risk that the requested P2P payment is associated with a fraudulent P2P scam or illicit activity such as money laundering, funding unlawful organizations (e.g., an FTO or criminal syndicate), or exchanging money associated with black market services (e.g., drug dealing, human trafficking, illegal weapon sales, or the like), among other examples.

For example, in some implementations, the P2P risk system may obtain, from various information sources, information associated with indicators related to fraudulent or illicit activity in P2P transactions, such as words, phrases, communication tactics, contextual nuances, communication patterns, linguistics, jargon, or other textual indicators used in known P2P payment scams or illicit activities. For example, P2P payment scams may include phishing tactics, where scammers or fraudsters pretend to be a trusted entity (e.g., a bank or payment platform) to trick a victim (e.g., the sending user) into revealing sensitive information such as a password, bank account information, or the like. In a phishing scam, the indicators of fraudulent activity may include email addresses that are disguised to have the appearance of a trusted entity, language that scammers use to create the appearance of being associated with a trusted entity, and/or language such as asking a user to click a link or provide sensitive information to fix a problem. In another P2P payment scam, known as an “accidental” transfer, a fraudster may claim to mistakenly send money to a P2P account of another user and request that the money be returned. After the money has been sent back to the fraudster, the victim may (or may not) discover that the initial funds were sent from a stolen or fake account, and may be held responsible for the stolen funds while the fraudster walks away with the victim's money. Furthermore, there are many other P2P payment scams, such as an impersonation scam, a fake product or service purchase, a work-from-home scam, a physical access scam, a pig butchering scam, or the like, and new P2P payment scams may emerge over time. In each P2P payment scam, fraudsters may use certain terms, employ certain tactics, or otherwise engage in communication patterns that can be modeled using machine learning or NLP techniques, and such information may be used by the P2P risk system to derive or otherwise obtain the indicators related to fraudulent or illicit activity in P2P transactions. Furthermore, in some cases, textual or linguistic indicators of fraudulent or illicit activities may include the use of certain slogans, slang terms or jargon, emojis or combinations of emojis, and/or letter substitutions (e.g., using an “!” instead of the letter “i” or “I”, using an “$” instead of the letter “s” or “S”, using deliberate misspellings or letter omissions, or insertion of random characters to avoid using certain words or phrases that filters are designed to easily detect).

In addition to textual or linguistic indicators of illicit activity, the indicators of fraudulent or illicit activity in P2P transactions may include techniques or tactics to structure P2P transactions or use P2P accounts in a way to avoid detection. For example, in a money laundering scheme, large transactions may be broken down into smaller transactions, in a technique known as “smurfing,” to complicate detection (e.g., by keeping transaction values below a threshold that triggers a reporting requirement or that may create suspicion), and/or may use a layering technique to create multiple layers of P2P transactions to obscure the origin and destination of funds and increase the difficulty of tracing a money flow. In other examples, criminals or fraudsters may use fake identities by combining real and fabricated information that may bypass identity verification mechanisms, account takeover techniques in which fraudsters gain access to legitimate user accounts and perform unauthorized P2P transactions that blend in with normal user behavior, cross-platform fraud by exploiting integrations with different P2P service providers and platforms to move funds quickly between P2P services and/or accounts and obscure transaction details, cross-border transactions that involve different regulatory environments, cryptocurrencies that can be converted to and from fiat currencies through P2P platforms to further obscure the traceability of the P2P transactions, and/or other advanced evasion techniques such as using artificial intelligence to simulate legitimate user behavior.

Accordingly, to assess the risk that the P2P transaction requested by the sending user is associated with fraudulent or illicit activity, the P2P risk system may receive textual information associated with the P2P transaction, such as text that the sending user provided in a memo or description to accompany the P2P transaction and/or text that the receiving user provided when requesting the P2P transaction (if applicable). In addition, the P2P transaction system may receive other relevant details of the P2P transaction, such as transactional parameters that include information related to the identities associated with the sending user and the receiving user, an amount of the P2P transaction, a form of payment used in the P2P transaction (e.g., bank account, credit card account, cryptocurrency, or the like), an account history associated with the sending user and the receiving user, and/or behavior patterns (e.g., typing patterns, device identifiers, or the like), among other examples. The P2P risk system may then analyze the textual information using NLP techniques to detect indicators of fraud or illicit activity.

For example, in some implementations, the NLP techniques used by the P2P risk system may include supervised learning based on labeled datasets, where text instances are tagged as fraudulent, indicative of criminal or illegal behavior, or legitimate, and algorithms such as logistic regression, support vector machines, and/or neural networks can be trained to classify new text data as fraudulent, illicit, or legitimate. Furthermore, the P2P risk system may use ensemble methods, where multiple classifiers are combined to improve the accuracy of fraud and/or illegal behavior detection, polarity detection to assess whether a sentiment expressed in the text accompanying the P2P transaction is positive, negative, or neutral (e.g., where fraudulent communications may often contain urgent, fearful, or overly optimistic language), emotion detection to identify specific emotions such as anger, fear, or excitement that can be indicative of fraud, and named entity recognition (NER) to identify and categorize entities such as names, dates, amounts, and organizations and detect unusual patterns, such as mismatched names or unexpected organizations. Furthermore, various other NLP techniques may be used by the P2P risk system, such as analyzing text to discover underlying topics that might be associated with fraudulent or illicit activities (e.g., repeated references to certain schemes or suspicious keywords), analyzing writing styles, grammar, and vocabulary usage for sudden changes in writing style or inconsistencies that can indicate fraudulent or illicit behavior, comparing text to known fraudulent or illicit communications using a cosine similarity or other similarity measures, among many others (e.g., outlier detection, behavioral profiling, recurrent neural networks (RNNs) and long short-term memory (LSTM), custom dictionaries (e.g., “urgent transfer,” “account verification”), and/or regular expression (regex) patterns).

Accordingly, as described herein, the P2P risk system may generally analyze the textual information associated with the P2P transaction using NLP techniques, alone or in combination with other machine learning techniques that may evaluate details of the P2P transaction, account histories, identity information, and/or account histories on other P2P service platforms to generate an indication that the P2P transaction is legitimate, or potentially associated with fraudulent or illicit activity. As shown by reference number 140, the P2P system may then provide the risk assessment to the P2P provider system, which may take appropriate action to process the requested P2P transaction in accordance with the indication. Additionally, or alternatively, the risk assessment provided by the P2P risk system may indicate whether the P2P transaction includes indicators of abusive behavior (e.g., harassment, threats, or the like). Additionally, or alternatively, the P2P risk system may provide an API or program module that can be integrated into a mobile application or website that is used to initiate the P2P transaction, and may perform NLP analysis and/or machine learning analysis to determine whether the requested P2P transaction includes indicators of fraud or illicit activity, before the request is received at the P2P provider system.

As shown by reference number 150, the risk assessment provided by the P2P risk system may trigger a remediation action by the P2P provider system, which may include blocking or flagging the P2P transaction when the risk assessment indicates that the P2P transaction has a high fraud or illicit behavior risk or a risk of containing abusive language. For example, the P2P system may block the P2P transaction from proceeding altogether, or the P2P system may allow the transaction to proceed, in order to allow for monitoring activity of the sending user or the receiving user (e.g., to trace a fraud or criminal network). Additionally, or alternatively, the risk assessment may trigger a risk assessment workflow, where the P2P transaction is manually or automatically reviewed to further assess the risk of fraud, illicit behavior, or abusive behavior (e.g., when the risk assessment indicates low confidence in a prediction that the P2P transaction is associated with fraud or illegal behavior). In such cases, where the P2P transaction is allowed to proceed, the P2P provider system may communicate with a P2P payment system (e.g., a system associated with a bank, a credit card issuer, or the like) to process the P2P transaction, as shown by reference number 160, and a notification or message may be sent to the receiver device or to an account associated with the receiver device (e.g., an email account or messaging account) to indicate the availability of the P2P payment. The activity of the sending user and/or the receiving user may then be monitored by the P2P provider system and/or other suitable systems (e.g., a law enforcement system) to apprehend potential fraudsters or criminals, or to engage in further investigation. Alternatively, in cases where the risk assessment provided by the P2P system indicates that the P2P transaction includes indicators of legitimate activity, the P2P provider system may process the P2P transaction through the P2P payment system as normal.

As indicated above, FIG. 1 is provided as an example. Other examples may differ from what is described with regard to FIG. 1.

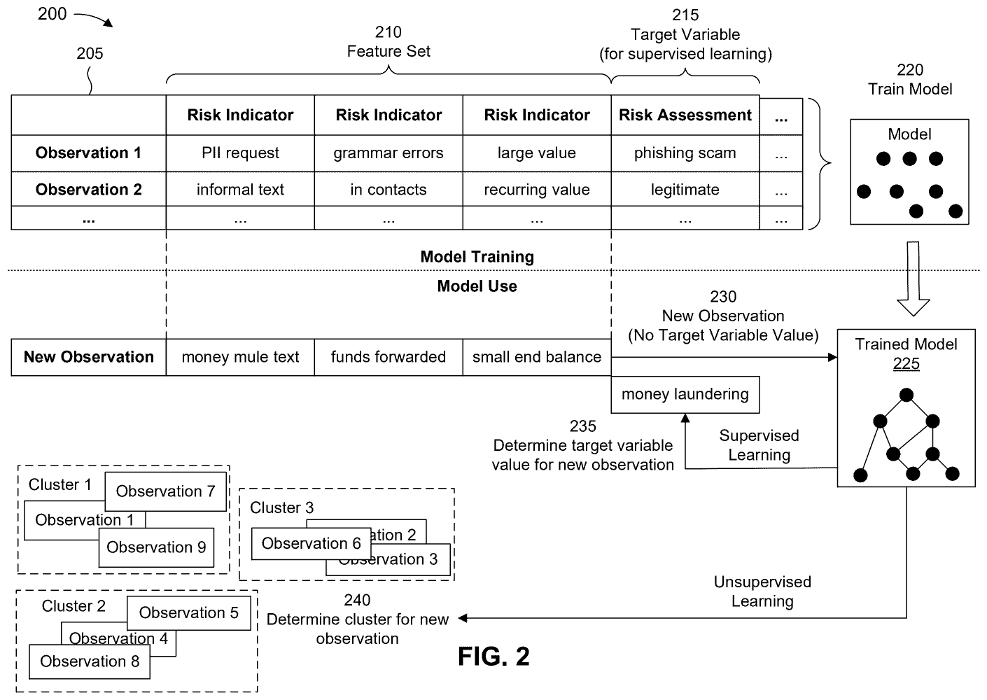

FIG. 2 is a diagram illustrating an example 200 of training and using a machine learning model in connection with detecting fraudulent or illicit activity in P2P transactions using NLP. The machine learning model training and usage described herein may be performed using a machine learning system. The machine learning system may include or may be included in a computing device, a server, a cloud computing environment, or the like, such as the P2P risk system and/or the P2P provider system described in more detail elsewhere herein.

As shown by reference number 205, a machine learning model may be trained using a set of observations. The set of observations may be obtained from training data (e.g., historical data), such as data gathered during one or more processes described herein. In some implementations, the machine learning system may receive the set of observations (e.g., as input) from the P2P risk system, the P2P provider system, the P2P payment system, and/or other suitable sources, as described elsewhere herein.

As shown by reference number 210, the set of observations may include a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from the P2P risk system, the P2P provider system, the P2P payment system, and/or other suitable sources. For example, the machine learning system may identify a feature set (e.g., one or more features and/or feature values) by extracting the feature set from structured data, by performing natural language processing to extract the feature set from unstructured data, and/or by receiving input from an operator.

As an example, a feature set for a set of observations may include one or more risk indicator features. As shown, for a first observation, the risk indicator features may have values such as PII request, grammar errors, a large value, and so on. These features and feature values are provided as examples, and may differ in other examples. For example, the feature set may include one or more of the following features: sentiment, mismatched name, outlier text, word sequences, and/or regex patterns, among other examples.

As shown by reference number 215, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiples classes, classifications, or labels) and/or may represent a variable having a Boolean value. A target variable may be associated with a target variable value, and a target variable value may be specific to an observation. In example 200, the target variable is risk assessment, which has a value of phishing scam for the first observation.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 220, the machine learning system may train a machine learning model using the set of observations and using one or more machine learning algorithms, such as a regression algorithm, a decision tree algorithm, a neural network algorithm, a k-nearest neighbor algorithm, a support vector machine algorithm, or the like. After training, the machine learning system may store the machine learning model as a trained machine learning model 225 to be used to analyze new observations.

As an example, the machine learning system may obtain training data for the set of observations based on text descriptions associated with P2P transactions that were reported to be fraudulent and/or associated with illicit activity or abusive behavior.

As shown by reference number 230, the machine learning system may apply the trained machine learning model 225 to a new observation, such as by receiving a new observation and inputting the new observation to the trained machine learning model 225. As shown, the new observation may include a first feature of money mule text, a second feature of funds forwarded, a third feature of small end-of-day balance, and so on, as an example. The machine learning system may apply the trained machine learning model 225 to the new observation to generate an output (e.g., a result), such as the new observation being that a P2P transaction may be associated with a money laundering scheme. The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs and/or information that indicates a degree of similarity between the new observation and one or more other observations, such as when unsupervised learning is employed.

As an example, the trained machine learning model 225 may predict a value of money laundering for the target variable of risk assessment for the new observation, as shown by reference number 235. Based on this prediction, the machine learning system may provide a first recommendation, may provide output for determination of a first recommendation, may perform a first automated action, and/or may cause a first automated action to be performed (e.g., by instructing another device to perform the automated action), among other examples. The first recommendation may include, for example, a recommendation to monitor the P2P transaction. The first automated action may include, for example, sending a message to a law enforcement agency to indicate that the P2P transaction may be associated with a money laundering scheme.

As another example, if the machine learning system were to predict a value of an accidental transfer fraud scheme for the target variable of risk assessment, then the machine learning system may provide a second (e.g., different) recommendation (e.g., a recommendation to block the P2P transaction) and/or may perform or cause performance of a second (e.g., different) automated action (e.g., sending a message to the sending user to indicate that the user requesting the P2P transaction may be attempting a P2P payment scam).

In some implementations, the trained machine learning model 225 may classify (e.g., cluster) the new observation in a cluster, as shown by reference number 240. The observations within a cluster may have a threshold degree of similarity. As an example, if the machine learning system classifies the new observation in a first cluster (e.g., fraud), then the machine learning system may provide a first recommendation, such as the first recommendation described above. Additionally, or alternatively, the machine learning system may perform a first automated action and/or may cause a first automated action to be performed (e.g., by instructing another device to perform the automated action) based on classifying the new observation in the first cluster, such as the first automated action described above.

In some implementations, the recommendation and/or the automated action associated with the new observation may be based on a target variable value having a particular label (e.g., classification or categorization), may be based on whether a target variable value satisfies one or more threshold (e.g., whether the target variable value is greater than a threshold, is less than a threshold, is equal to a threshold, falls within a range of threshold values, or the like), and/or may be based on a cluster in which the new observation is classified.

In some implementations, the trained machine learning model 225 may be re-trained using feedback information. For example, feedback may be provided to the machine learning model. The feedback may be associated with actions performed based on the recommendations provided by the trained machine learning model 225 and/or automated actions performed, or caused, by the trained machine learning model 225. In other words, the recommendations and/or actions output by the trained machine learning model 225 may be used as inputs to re-train the machine learning model (e.g., a feedback loop may be used to train and/or update the machine learning model). For example, the feedback information may include an outcome from a risk assessment workflow indicating that a potentially fraudulent P2P transaction was determined to be legitimate or determined to be fraudulent.

In this way, the machine learning system may apply a rigorous and automated process to detect fraudulent and/or illicit activity in P2P transactions. The machine learning system may enable recognition and/or identification of tens, hundreds, thousands, or millions of features and/or feature values for tens, hundreds, thousands, or millions of observations, thereby increasing accuracy and consistency and reducing delay associated with detecting fraudulent and/or illicit activity in P2P transactions relative to requiring computing resources to be allocated for tens, hundreds, or thousands of operators to manually detecting fraudulent and/or illicit activity in P2P transactions using the features or feature values.

As indicated above, FIG. 2 is provided as an example. Other examples may differ from what is described in connection with FIG. 2.

FIG. 3 is a diagram of an example environment 300 in which systems and/or methods described herein may be implemented. As shown in FIG. 3, environment 300 may include a sender device 310, a receiver device 320, a P2P provider system 330, a P2P payment system 340, a P2P risk system 350, and a network 360. Devices of environment 300 may interconnect via wired connections, wireless connections, or a combination of wired and wireless connections.

The sender device 310 may include one or more devices capable of receiving, generating, storing, processing, and/or providing information associated with a P2P transaction, as described elsewhere herein. The sender device 310 may include a communication device and/or a computing device. For example, the sender device 310 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device.

The receiver device 320 may include one or more devices capable of receiving, generating, storing, processing, and/or providing information associated with a P2P transaction, as described elsewhere herein. The receiver device 320 may include a communication device and/or a computing device. For example, the sender device 310 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device.

Additionally, or alternatively, the receiver device 320 may include one or more devices capable of facilitating a P2P transaction. For example, the receiver device 320 may include a point-of-sale (PoS) terminal, a payment terminal (e.g., a credit card terminal, a contactless payment terminal, a mobile credit card reader, or a chip reader), and/or an automated teller machine (ATM). The receiver device 320 may include one or more input components and/or one or more output components to facilitate obtaining data (e.g., account information) from the sender device 310 and/or to facilitate interaction with and/or authorization from a user of the sender 310. Example input components of the receiver device 320 include a number keypad, a touchscreen, a magnetic stripe reader, a chip reader, and/or a radio frequency (RF) signal reader (e.g., a near-field communication (NFC) reader). Example output devices of the receiver device 320 include a display and/or a speaker.

The P2P provider system 330 may include one or more devices capable of receiving, generating, storing, processing, providing, and/or routing information associated with detecting fraudulent or illicit activity in P2P transactions using NLP, as described elsewhere herein. The P2P provider system 330 may include a communication device and/or a computing device. For example, the P2P provider system 330 may include a server, such as an application server, a client server, a web server, a database server, a host server, a proxy server, a virtual server (e.g., executing on computing hardware), or a server in a cloud computing system. In some implementations, the P2P provider system 330 may include computing hardware used in a cloud computing environment.

The P2P payment system 340 may include one or more devices capable of processing, authorizing, and/or facilitating a P2P transaction. For example, the P2P payment system 340 may include one or more servers and/or computing hardware (e.g., in a cloud computing environment or separate from a cloud computing environment) configured to receive and/or store information associated with processing a P2P transaction. The P2P payment system 340 may process a P2P transaction, such as to approve (e.g., permit, authorize, or the like) or decline (e.g., reject, deny, or the like) the P2P transaction and/or to complete the P2P transaction if the P2P transaction is approved. The P2P payment system 340 may process the transaction based on information received from the P2P provider system 330, such as transaction data (e.g., information that identifies a P2P transaction amount, a sender, a receiver, a time of a transaction, a location of the transaction, or the like), account information communicated to the P2P provider system 330 by the sender device 310 and/or the receiver device 320, and/or information stored by the P2P payment system 340 (e.g., for fraud and/or illicit activity detection).

The P2P payment system 340 may be associated with a financial institution (e.g., a bank, a lender, a credit card company, or a credit union) and/or may be associated with a transaction card association that authorizes a transaction and/or facilitates a transfer of funds. For example, the P2P payment system 340 may be associated with a bank linked to an account associated with a user of the sender device 310 and/or a user of the receiver device 320 and/or a transaction card association (e.g., VISA® or MASTERCARD®) associated with a credit card account, debit card account, or other payment credential linked to an account associated with a user of the sender device 310 and/or a user of the receiver device 320. Based on receiving information associated with the P2P transaction from the P2P provider system 330, one or more devices of the P2P payment system 340 may communicate to authorize a P2P transaction and/or to transfer funds from an account associated with the user of the sender device 310 and/or transfer funds to an account of the user of the receiver device 320.

The P2P risk system 350 may include one or more devices capable of receiving, generating, storing, processing, providing, and/or routing information associated with detecting fraudulent or illicit activity in P2P transactions using NLP, as described elsewhere herein. The P2P risk system 350 may include a communication device and/or a computing device. For example, the P2P risk system 350 may include a server, such as an application server, a client server, a web server, a database server, a host server, a proxy server, a virtual server (e.g., executing on computing hardware), or a server in a cloud computing system. In some implementations, the P2P risk system 350 may include computing hardware used in a cloud computing environment.

The network 360 may include one or more wired and/or wireless networks. For example, the network 360 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 360 enables communication among the devices of environment 300.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of environment 300 may perform one or more functions described as being performed by another set of devices of environment 300.

FIG. 4 is a diagram of example components of a device 400 associated with detecting fraudulent or illicit activity in P2P transactions using NLP. The device 400 may correspond to the sender device 310, the receiver device 320, the P2P provider system 330, the P2P payment system 340, and/or the P2P risk system 350. In some implementations, the sender device 310, the receiver device 320, the P2P provider system 330, the P2P payment system 340, and/or the P2P risk system 350 may include one or more devices 400 and/or one or more components of the device 400. As shown in FIG. 4, the device 400 may include a bus 410, a processor 420, a memory 430, an input component 440, an output component 450, and/or a communication component 460.

The bus 410 may include one or more components that enable wired and/or wireless communication among the components of the device 400. The bus 410 may couple together two or more components of FIG. 4, such as via operative coupling, communicative coupling, electronic coupling, and/or electric coupling. For example, the bus 410 may include an electrical connection (e.g., a wire, a trace, and/or a lead) and/or a wireless bus. The processor 420 may include a central processing unit, a graphics processing unit, a microprocessor, a controller, a microcontroller, a digital signal processor, a field-programmable gate array, an application-specific integrated circuit, and/or another type of processing component. The processor 420 may be implemented in hardware, firmware, or a combination of hardware and software. In some implementations, the processor 420 may include one or more processors capable of being programmed to perform one or more operations or processes described elsewhere herein.

The memory 430 may include volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 may store information, one or more instructions, and/or software (e.g., one or more software applications) related to the operation of the device 400. In some implementations, the memory 430 may include one or more memories that are coupled (e.g., communicatively coupled) to one or more processors (e.g., processor 420), such as via the bus 410. Communicative coupling between a processor 420 and a memory 430 may enable the processor 420 to read and/or process information stored in the memory 430 and/or to store information in the memory 430.

The input component 440 may enable the device 400 to receive input, such as user input and/or sensed input. For example, the input component 440 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 450 may enable the device 400 to provide output, such as via a display, a speaker, and/or a light-emitting diode. The communication component 460 may enable the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

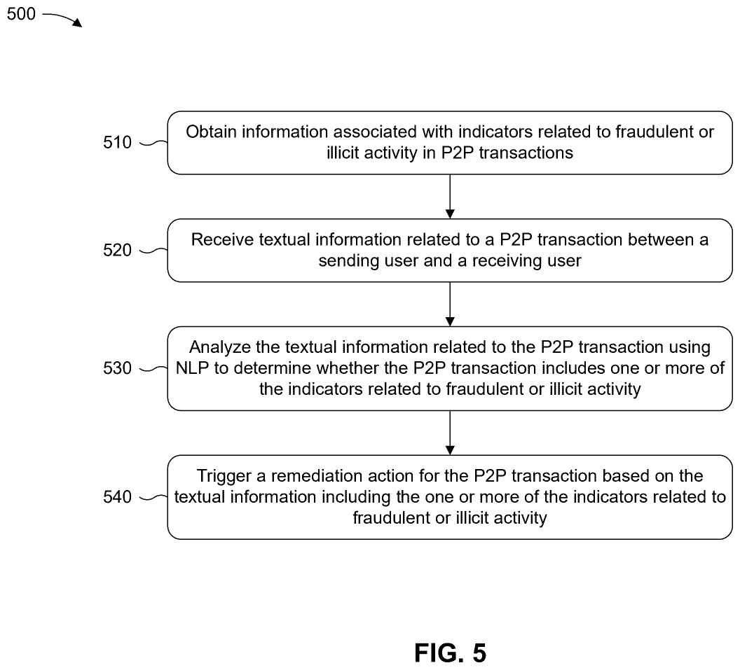

FIG. 5 is a flowchart of an example process 500 associated with detecting fraudulent or illicit activity in P2P transactions using NLP. In some implementations, one or more process blocks of FIG. 5 may be performed by the P2P risk system 350. In some implementations, one or more process blocks of FIG. 5 may be performed by another device or a group of devices separate from or including the P2P risk system 350, such as the sender device 310, the receiver device 320, the P2P provider system 330, and/or the P2P payment system 340. Additionally, or alternatively, one or more process blocks of FIG. 5 may be performed by one or more components of the device 400, such as processor 420, memory 430, input component 440, output component 450, and/or communication component 460.

As shown in FIG. 5, process 500 may include obtaining information associated with indicators related to fraudulent or illicit activity in P2P transactions (block 510). For example, the P2P risk system 350 (e.g., using processor 420 and/or memory 430) may obtain information associated with indicators related to fraudulent or illicit activity in P2P transactions, as described above in connection with reference number 130 of FIG. 1. As an example, the indicators related to fraudulent or illicit activity in P2P transactions may include words, phrases, communication tactics, communication patterns, jargon, letter substitutions, emoji usage, or other language-based indicators associated with known P2P payment scams and/or misuse of P2P payment services to further illegal behaviors or fund unlawful organizations.

As further shown in FIG. 5, process 500 may include receiving textual information related to a P2P transaction between a sending user and a receiving user (block 520). For example, the P2P risk system 350 (e.g., using processor 420, memory 430, input component 440, and/or communication component 460) may receive textual information related to a P2P transaction between a sending user and a receiving user, as described above in connection with reference number 120 of FIG. 1. As an example, the textual information related to the P2P transaction may include text that the sending user provided in a memo to accompany the P2P transaction (e.g., “Thanks for the stuff, wink wink”). Additionally, or alternatively, the textual information related to the P2P transaction may include text that the receiving user provided to request the P2P transaction (e.g., “I have an urgent request. I mistakenly sent a payment to you that was intended for someone else. Can you please send the money back?”).

As further shown in FIG. 5, process 500 may include analyzing the textual information related to the P2P transaction using NLP to determine whether the P2P transaction includes one or more of the indicators related to fraudulent or illicit activity (block 530). For example, the P2P risk system 350 (e.g., using processor 420 and/or memory 430) may analyze the textual information related to the P2P transaction using NLP to determine whether the P2P transaction includes one or more of the indicators related to fraudulent or illicit activity, as described above in connection with reference number 130 of FIG. 1. As an example, the textual information may be analyzed using text classification, sentiment analysis, topic modeling, anomaly detection, keyword and phrase detection, language and style analysis, dependency parsing and syntax analysis, and/or other suitable NLP techniques to detect indicators of fraudulent or illicit activity.

As further shown in FIG. 5, process 500 may include triggering a remediation action for the P2P transaction based on the textual information including one or more of the indicators related to fraudulent or illicit activity (block 540). For example, the P2P risk system 350 (e.g., using processor 420 and/or memory 430) may trigger a remediation action for the P2P transaction based on the textual information including one or more of the indicators related to fraudulent or illicit activity, as described above in connection with reference number 140 and/or reference number 150 of FIG. 1. As an example, the remediation action may be to block the P2P transaction from proceeding, to monitor activities of the sending user and/or the receiving user, to further analyze the P2P transaction for fraud and/or illicit activity indicators, or the like.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel. The process 500 is an example of one process that may be performed by one or more devices described herein. These one or more devices may perform one or more other processes based on operations described herein, such as the operations described in connection with FIG. 1. Moreover, while the process 500 has been described in relation to the devices and components of the preceding figures, the process 500 can be performed using alternative, additional, or fewer devices and/or components. Thus, the process 500 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for detecting fraudulent or illicit activity in peer-to-peer (P2P) transactions, the system comprising:
one or more memories; and
one or more processors, communicatively coupled to the one or more memories, configured to:
obtain information associated with indicators related to fraudulent or illicit activity in P2P transactions;
receive textual information related to a P2P transaction between a sending user and a receiving user,
wherein the textual information related to the P2P transaction includes one or more of text that the sending user provided in a memo to accompany the P2P transaction or text that the receiving user provided to request the P2P transaction;
analyze the textual information related to the P2P transaction using natural language processing (NLP) to determine whether the P2P transaction includes one or more of the indicators related to fraudulent or illicit activity; and
trigger a remediation action for the P2P transaction based on the textual information including one or more of the indicators related to fraudulent or illicit activity.

2. The system of claim 1, wherein the remediation action is to block the P2P transaction between the sending user and the receiving user.

3. The system of claim 1, wherein the remediation action is to initiate a risk assessment workflow to review the P2P transaction or monitor activity associated with one or more of the sending user or the receiving user.

4. The system of claim 1, wherein the one or more processors are further configured to:
receive transactional parameters related to the P2P transaction between the sending user and the receiving user,
wherein the transactional parameters include one or more of a value of the P2P transaction, information related to one or more behavior patterns associated with an account of the sending user, or one or more behavior patterns associated with an account of the receiving user; and
analyze the transactional parameters related to the P2P transaction using machine learning techniques to determine whether the P2P transaction includes one or more of the indicators related to fraudulent or illicit activity in P2P transactions,
wherein the remediation action is triggered based on the transactional parameters including one or more of the indicators related to fraudulent or illicit activity.

5. The system of claim 1, wherein the information associated with the indicators related to fraudulent or illicit activity in P2P transactions includes words, phrases, or communication tactics associated with known fraudulent schemes, illegal behaviors, or unlawful organizations.

6. The system of claim 1, wherein the information associated with the indicators related to fraudulent or illicit activity in P2P transactions includes transactional patterns or account usage patterns associated with tactics used in known fraudulent schemes, illegal behaviors, or unlawful organizations.

7. The system of claim 1, wherein the indicators related to fraudulent or illicit activity in P2P transactions include one or more of obfuscation techniques to mask one or more words or phrases or behavior patterns associated with structuring P2P transactions to evade detection.

8. The system of claim 1, wherein the one or more processors are further configured to:
analyze the textual information related to the P2P transaction using NLP to determine whether the textual information includes one or more indicators of abusive behavior,
wherein the remediation action is triggered for the P2P transaction based on the textual information including the one or more indicators of abusive behavior.

9. The system of claim 1, wherein the one or more processors are further configured to:
receive, from a user device associated with the sending user, a request for the P2P transaction between the sending user and the receiving user,
wherein the remediation action is triggered in connection with processing the request for the P2P transaction.

10. The system of claim 1, wherein the one or more processors are further configured to:
receive, from a requesting system, an application program interface (API) call that includes a request to assess the P2P transaction for fraudulent or illicit activity,
wherein information to trigger the remediation action for the P2P transaction is sent to the requesting system.

11. A method for assessing a risk of fraudulent or illicit activity in peer-to-peer (P2P) transactions, comprising:
obtaining, by a system, information associated with indicators related to fraudulent or illicit activity in P2P transactions;
receiving, from a user device associated with a sending user, a request for a P2P transaction between the sending user and a receiving user;
analyzing, by the system, textual information related to the P2P transaction using natural language processing (NLP) to determine whether the P2P transaction includes one or more of the indicators related to fraudulent or illicit activity,
wherein the textual information related to the P2P transaction includes one or more of text that the sending user provided in a memo to accompany the P2P transaction or text that the receiving user provided to request the P2P transaction; and
processing, by the system, the request for the P2P transaction in accordance with whether the P2P transaction includes one or more of the indicators related to fraudulent or illicit activity, wherein processing the request for the P2P transaction includes:
triggering a remediation action for the P2P transaction based on the textual information including one or more indicators related to fraudulent or illicit activity; or
processing the P2P transaction based on the textual information lacking indicators related to fraudulent or illicit activity or including indicators of legitimate activity.

12. The method of claim 11, wherein the remediation action includes blocking the P2P transaction between the sending user and the receiving user or initiating a risk assessment workflow to review the P2P transaction or monitor activity associated with one or more of the sending user or the receiving user.

13. The method of claim 11, further comprising:
analyzing transactional parameters related to the P2P transaction using machine learning techniques to determine whether the P2P transaction includes one or more of the indicators related to fraudulent or illicit activity in P2P transactions,
wherein the transactional parameters include one or more of a value of the P2P transaction, information related to one or more behavior patterns associated with an account of the sending user, or one or more behavior patterns associated with an account of the receiving user.

14. The method of claim 11, wherein the information associated with the indicators related to fraudulent or illicit activity in P2P transactions includes words, phrases, or communication tactics associated with known fraudulent schemes, illegal behaviors, or unlawful organizations.

15. The method of claim 11, wherein the information associated with the indicators related to fraudulent or illicit activity in P2P transactions includes transactional patterns or account usage patterns associated with tactics used in known fraudulent schemes, illegal behaviors, or unlawful organizations.

16. The method of claim 11, wherein the indicators related to fraudulent or illicit activity in P2P transactions include one or more of obfuscation techniques to mask one or more words or phrases or behavior patterns associated with structuring P2P transactions to evade detection.

17. A non-transitory computer-readable medium storing a set of instructions, the set of instructions comprising:
one or more instructions that, when executed by one or more processors of a system, cause the system to:
obtain information associated with indicators related to fraudulent or illicit activity in P2P transactions;
receive, from a requesting system, an application program interface (API) call that includes a request to assess a P2P transaction between a sending user and a receiving user for fraudulent or illicit activity and indicates information related to the P2P transaction,
wherein the information indicated in the request includes one or more of text that the sending user provided in a memo to accompany the P2P transaction, text that the receiving user provided to request the P2P transaction, a value of the P2P transaction, information related to one or more behavior patterns associated with an account of the sending user, or information related to one or more behavior patterns associated with an account of the receiving user;
analyze the information related to the P2P transaction using one or more machine learning models to determine whether the P2P transaction includes one or more of the indicators related to fraudulent or illicit activity; and
send, to the requesting system, an indication of whether the P2P transaction includes one or more of the indicators related to fraudulent or illicit activity.

18. The non-transitory computer-readable medium of claim 17, wherein the information associated with the indicators related to fraudulent or illicit activity in P2P transactions includes words, phrases, or communication tactics associated with known fraudulent schemes, illegal behaviors, or unlawful organizations.

19. The non-transitory computer-readable medium of claim 17, wherein the information associated with the indicators related to fraudulent or illicit activity in P2P transactions includes transactional patterns or account usage patterns associated with tactics used in known fraudulent schemes, illegal behaviors, or unlawful organizations.

20. The non-transitory computer-readable medium of claim 17, wherein the indicators related to fraudulent or illicit activity in P2P transactions include one or more of obfuscation techniques to mask one or more words or phrases or behavior patterns associated with structuring P2P transactions to evade detection.
